(19) United States
(12) Patent Application Publication
(10) Pub. No.: US 2010/0107893 A1
(43) Pub. Date: May 6, 2010

(54) FOOD PROCESSOR ARRANGEMENTS

(76) Inventor: Christina Goodrick-Meech, Hampshire (GB)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/440,072

(22) PCT Filed: Aug. 10, 2007
(86) PCT No.: PCT/GB07/03044

§ 371 Date: Dec. 18, 2009

(30) Foreign Application Priority Data
Sep. 8, 2006 (GB) 0617643.2

(51) Int. Cl. A47J 43/046; A47J 43/07

(52) U.S. Cl. 99/348; 99/537; 241/282.1

(57) ABSTRACT

A food processor arrangement comprises an electrically powered blender (10, 50) having a working receptacle (70) within which ingredients can be processed, by means of a macerating tool (71), and heated. The receptacle (70) is provided with a lid (72) formed with an aperture (73) through which additional ingredients can be introduced into the receptacle (70), and the arrangement further comprises a ladle (74) mounted to a shank (75) dimensioned to pass through the aperture (73) so that the ladle (74) can be manipulated to sample the content of the receptacle (70). The ladle (74) can be used without fouling the tool (71), and the ladle (74) comprises a spoon-like portion (79) for sampling the stock; the aperture (73) in the lid (72) of the receptacle (70) being elongated in one dimension to accommodate withdrawal of the spoon-like portion (79). Preferably an internal wall portion (81) of the receptacle (70) supports a container (82) for seasoning materials intended to impart flavourings and/or aromas to ingredients in a liquid stock.

This invention relates to food processor arrangements, and it relates especially, though not exclusively, to such arrangements adapted for preparing heated beverages, such as soup.

Food processing appliances are well known and established as useful and reasonably priced kitchen appliances with a reasonably broad range of capabilities. Because of design constraints, some of which have their origins in the pricing structure which has become established for such appliances, however, food processors do not tend to exhibit the broadly-based functionality of the more expensive stand-mixers. Nevertheless, it has long been proposed to provide food processors with heating capabilities, thereby to permit the preparation of heated beverages and such proposals are currently being revisited and redeveloped.

One particularly effective heated beverage processor is described in WO 2005/037036 A1; the processor as described therein being currently marketed as the Kenwood Frothie. This appliance is primarily intended for making hot drinks, such as cocoa and chocolate drinks, which benefit from blending as well as heating, and which can conveniently be dispensed from the working receptacle, or goblet, of the appliance through a tap provided at the base of the goblet.

In further developing blending and heating appliances, attention has been directed at the provision of blenders capable of heavier duty operation with the capability, for example, of usage for preparing the ingredients for, and then heating, more substantial comestibles, such as soups. In that regard, certain difficulties are encountered in relation to (a) the stirring and sampling operations that are customarily employed when making soup, and (b) the addition of seasonings by ingredients, such as bay leaves, which are best kept separate from the soup stock.

The invention aims to reduce or eliminate at least one of the above difficulties.

According to the invention from one aspect, there is provided a food processor arrangement comprising an electrically powered blender having a working receptacle within which ingredients can be processed by means of a macerating tool rotatable by means of an electric motor and heated by means of an electrically powered heater, wherein the receptacle is provided with a lid formed with an aperture through which additional ingredients can be introduced into the receptacle wherein the arrangement further comprises a ladle mounted to a shank dimensioned so as, in use, to pass through said aperture whereby the ladle can be manipulated to sample the content of the receptacle and configured such that the ladle can be used, during operation of the motor and/or the heater of the blender, to manually stir or otherwise manipulate the ingredients without fouling the said tool.

Typically, the ingredients may include a liquid stock, as with a soup, and in such circumstances the ladle conveniently comprises a spoon-like portion for sampling, and the aperture in the lid of the receptacle is elongated in one dimension to accommodate withdrawal of the spoon-like portion therethrough.

It is preferred that the underside of the spoon-like portion is shaped with a concavity to facilitate pushing floating ingredients down into the stock to ensure thorough heating of such floating ingredients.

Conveniently, the shank of the ladle is fitted with a stop configured to interact with a plurality of edge portions of the aperture in the lid of the receptacle to form a stop at such a position as to ensure that the ladle cannot foul the tool.

According to the invention from another aspect there is provided a food processor arrangement comprising an electrically powered blender having a working receptacle within which ingredients can be processed by means of a macerating tool rotatable by means of an electric motor and heated by means of an electrically powered heater, wherein an internal wall portion of the receptacle supports a container for seasoning materials intended to impart flavourings and/or aromas to ingredients in a liquid stock.

Preferably, the container is provided with at least one foraminate wall structure having apertures sited and dimensioned to allow liquid stock to enter the container, interact with the seasoning materials therein and leave the container, whilst retaining at least a major portion of the seasoning materials within the container.

In some preferred embodiments of the invention, the container is located with said at least one foraminate wall structure at or proximate to a region of the receptacle at which relatively high flow rates are imparted to the liquid stock when said tool is rotated by said motor.

The said internal wall of the receptacle may conveniently be formed with retaining means permitting at least the said foraminate wall, and preferably the entire container, to be removed for cleaning and/or replacement.

In other preferred embodiments of the invention, a range of interchangeable containers, or at least the foraminate walls thereof, formed with differently dimensioned apertures for liquid ingress and egress may be provided for use with differing kinds of flavouring materials.

In order that the invention may be clearly understood and readily carried into effect, certain embodiments thereof will now be described, by way of example only, with reference to the accompanying drawings, of which:

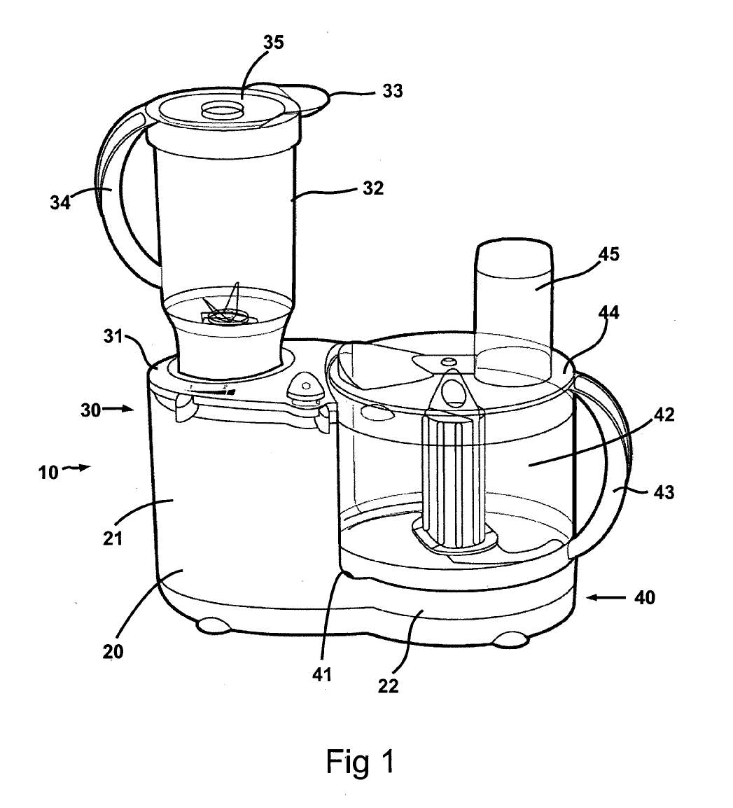

FIG. 1 shows, in general perspective view, one example of a typical food processor;

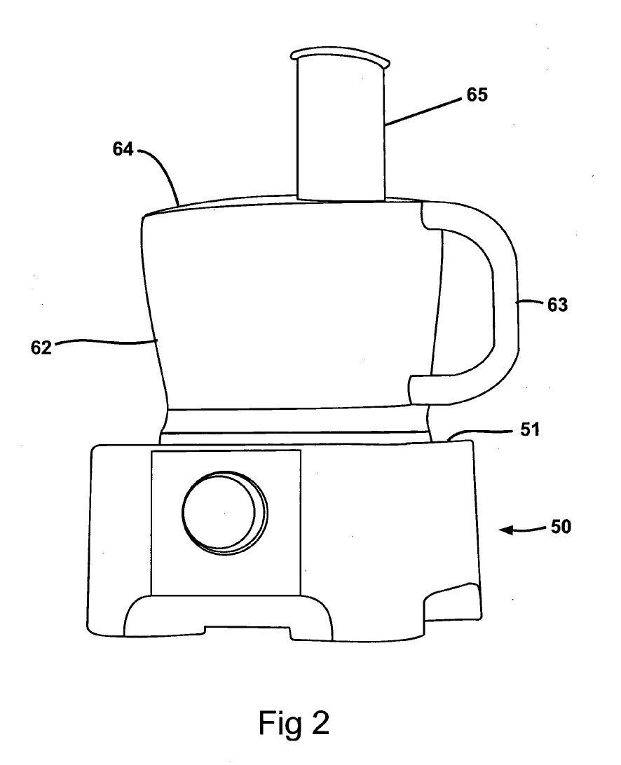

FIG. 2 shows in general perspective view, another example of a typical food processor;

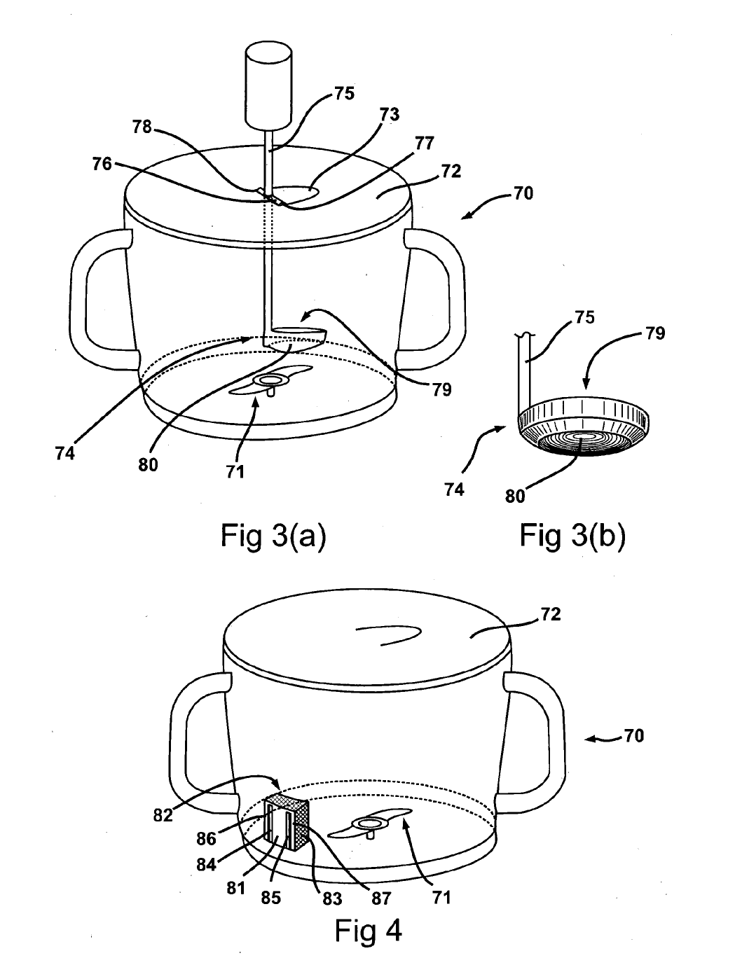

FIG. 3(a) shows a receptacle and an associated ladle components adapted for use in an arrangement according to a first embodiment of the invention;

FIG. 3(b) shows a detailed perspective view of part of the ladle component illustrated in FIG. 3(a); and

FIG. 4 shows, in similar view to FIG. 3, a receptacle and associated components adapted for use in an arrangement according to a second embodiment of the invention.

Referring now to FIG. 1, there is shown an example of a food processor which can advantageously host an arrangement in accordance with an embodiment of the invention.

The food processor 10 shown in FIG. 1 includes a casing 20 which, as is well known, houses an electric motor (not shown) and a drive system (not shown) disposed and arranged to provide rotational drive outputs for use with a blender section 30 and a food processor section 40.

The blender section 30 comprises a relatively high platform 31, atop the part 21 of the casing 20 which houses the motor; the platform having associated therewith a relatively high speed drive outlet, typically running at the operational speed of the motor and configured to drive a rotary tool located in the base of a receptacle 32, such as a goblet. The goblet is typically formed with a spout 33 and a handle 34, and capped by a removable lid 35; the receptacle 32 may take any convenient form, however. An interlock system is normally provided to prevent operation of the motor unless the lid 35 is correctly attached to the goblet 32.

The food processor section 40 comprises a relatively low platform 41 beneath which, and within a lower part 22 of the casing 20, are provided elements of a speed-reduction system, linked to the motor, which provides, centrally of the platform 41, a relatively lower speed drive outlet capable of rotating cutting, chopping and other food processing tools inserted into a blender bowl 42. The bowl 42 has a handle 43, a lid 44 and a feed-tube 45 through which ingredients can be added to the bowl whilst the motor is running, provided that the lid 44 is in place on the bowl 42.

Usually, the dimensions of the feed tube 45 are configured so as to prevent insertion of a user's hands or fingers into the bowl therethrough, at least to within touching distance of the rotating tool. Some food processors, however, utilise a wide feed-tube to allow the addition of relatively large ingredients to the bowl. Such wide feed-tubes are provided with further interlocks to protect the user; such further interlocks usually being based around the detection of a pushing device in correct placement in the tube, whereby the user has to employ the pushing device to urge ingredients into the bowl 42, and the motor will not run unless the pushing device is located in the feed-tube.

The present invention can be advantageously applied to food processors of varying kinds, such as (by way of example only) the kind shown in FIG. 1 and that shown in FIG. 2, wherein the processor 50 comprises a box-like casing which supports a single platform 51 which can support and drive (by way of coaxially located drive outlets, as is known) rotary tools comprised in either a blender receptacle (not shown) or a food processor bowl 62. The bowl 62 has a handle 63, a lid 64 and a feed-tube 65, similar to the components 43, 44 and 45 of the processor described with reference to FIG. 1, and to which similar comments apply.

In accordance with one example of the invention, and as shown in FIGS. 3(a) and 3(b), a food processor arrangement of any convenient kind, for example in accordance with either of the configurations shown in FIGS. 1 and 2, is provided with a heating capability, for example in the manner described in the aforementioned WO 2005/037036 A1. However the processor and its heating are configured, there is provided a working receptacle 70 within which ingredients can be processed by means of a macerating tool 71, rotatable by means of the processor's electric motor, and/or heated by means of the aforementioned heater. The receptacle 70 is provided with a lid 72 formed with an aperture 73 through which additional ingredients can be introduced, before and/or during an operating cycle of the food processor, into the receptacle 70.

The arrangement further comprises a ladle 74, mounted to a shank 75 which is dimensioned to pass through the aperture 73, so that the ladle can be manipulated to sample the content of the receptacle 70.

The ladle 74 is further configured so as to be usable, during operation of the motor and/or the heater of the blender, to manually stir or otherwise manipulate the ingredients in the receptacle 70 without fouling the tool 71 and, in this respect, the shank 75 of the ladle is (in this example of the invention), fitted with a stop 76 configured to interact with a plurality of edge portions 77, 78 of the aperture 73 in the lid of the receptacle 70 to form a stop at such a position as to ensure that the ladle 74 cannot foul the tool 71.

Typically, the ingredients will include a liquid stock, as with a soup, and in such circumstances the ladle 74 conveniently comprises a spoon-like portion 79 for sampling, and the aperture 73 in the lid of the receptacle is elongated in one dimension to accommodate withdrawal therethrough of the spoon-like portion 79 of the ladle 74.

As best seen in FIG. 3(b), it is preferred that the underside of the spoon-like portion 79 of the ladle 74 is shaped with a concavity 80 to facilitate pushing floating ingredients down into the stock to ensure thorough heating of such floating ingredients.

As will now be described with reference to FIG. 4, the invention further provides, in accordance with a configuration regarded as inventive of itself, and which may be used together with the arrangement described with reference to FIGS. 3(a) and 3(b) or independently thereof, a food processor arrangement of any convenient kind, again comprising an electrically powered blender having a working receptacle 70 within which ingredients can be processed by means of a macerating tool 71 that is rotatable by means of an electric motor and heated by means of an electrically powered heater, but differing from the previously described construction in that an internal wall portion 81 of the receptacle 70 supports a container 82 for seasoning materials intended to impart flavourings and/or aromas to ingredients in a liquid stock. The container 82 is preferably constructed as a basket, with open mesh sides but in any event is provided with at least one foraminate wall structure 83, the perforations of which are sited and dimensioned to allow liquid stock to enter the container 82, interact with the seasoning materials therein and leave the container, whilst retaining at least a major portion of the seasoning materials within the container.

In some preferred embodiments of the invention, the container 82 is located with the at least one foraminate wall structure 83 at, or proximate to, a region of the receptacle 70 at which relatively high flow rates are imparted to the liquid stock when the tool 71 is rotated by the motor.

The said internal wall portion 81 of the receptacle 70 is conveniently formed with retaining means, such as vertically-orientated runner portions 84, 85, permitting at least the said foraminate wall 83, and preferably the entire container 82, to be removed for cleaning and/or replacement. The container 82 as a whole, or merely the foraminate wall 83 thereof, depending which is to be removable, is provided with co-operative slider members 86, 87 which engage with and slide relative to the runner portions 84, 85, thereby to locate the seasoning container 82 on the portion 81 of the inner wall of the receptacle 70 in which the ingredients are to be processed and/or heated.

It will be appreciated that, instead of using runners such as 84, 85 to permit removal and insertion of the seasoning container 82 or a wall 83 thereof, latches, suction pads or, indeed, any convenient means of temporary attachment can be used. Criteria which influence the choice of attachment means include ease of cleaning, the magnitudes of the forces transmitted to the container by the agitated fluid during operation of the processing tool and mechanical strength in relation to the dimensions of the container.

In other preferred embodiments of the invention, a range of interchangeable seasoning containers 82, or at least the foraminate walls such as 83 thereof, formed with differently dimensioned apertures for liquid ingress and egress may be provided for use with differing kinds of seasonings.

1. A food processor arrangement comprising an electrically powered blender (10, 50) having a working receptacle (70) within which ingredients can be processed by means of a macerating tool (71) rotatable by means of an electric motor and heated by means of an electrically powered heater, wherein the receptacle (70) is provided with a lid (72) formed with an aperture (73) through which additional ingredients can be introduced into the receptacle (70) wherein the arrangement further comprises a ladle (74) mounted to a shank (75) dimensioned so as, in use, to pass through said aperture (73) whereby the ladle (74) can be manipulated to sample the content of the receptacle (70) and configured such that the ladle (74) can be used, during operation of the motor and/or the heater of the blender, to manually stir or otherwise manipulate the ingredients without fouling the said tool (71).

2. An arrangement according to claim 1, wherein the ingredients include a liquid stock, as with a soup, and wherein the ladle (74) comprises a spoon-like portion (79), out of line with the shank (75), for sampling the stock.

3. An arrangement according to claim 2, wherein the said aperture (73) in the lid (72) of the receptacle (70) is elongated in one dimension to accommodate withdrawal of the spoon-like portion (79) therethrough.

4. An arrangement according to claim 2, wherein the underside of the spoon-like portion (79) is shaped with a concavity (80) to facilitate pushing floating ingredients down into the stock to ensure thorough heating of such floating ingredients.

5. An arrangement according to claim 1, wherein the shank (75) of the ladle is fitted with a stop (76) configured to interact with a plurality of edge portions (77, 78) of the aperture (73) in the lid of the receptacle (70) to form a stop at such a position as to ensure that the ladle (74) cannot foul the tool (71).

6. An arrangement according to claim 1, wherein an internal wall portion (81) of the receptacle (70) supports a container (82) for seasoning materials intended to impart flavourings and/or aromas to ingredients in a liquid stock.

7. A food processor arrangement comprising an electrically powered blender (10, 50) having a working receptacle (70) within which ingredients can be processed by means of a macerating tool (71) rotatable by means of an electric motor and heated by means of an electrically powered heater, wherein an internal wall portion (81) of the receptacle (70) supports a container (82) for seasoning materials intended to impart flavourings and/or aromas to ingredients in a liquid stock.

8. An arrangement according to claim 6, wherein the container (82) comprises at least one foraminate wall structure (83) with apertures sited and dimensioned to allow liquid stock to enter the container (82), interact with the seasoning materials therein and leave the container (82), whilst retaining at least a major portion of the seasoning materials within the container (82).

9. An arrangement according to claim 7, wherein the container (82) is located with said at least one foraminate wall structure (83) at or proximate to a region of the receptacle (70) at which relatively high flow rates are imparted to the liquid stock when said tool (71) is rotated by said motor.

10. An arrangement according to claim 7, wherein said internal wall (81) of the receptacle (70) is formed with retaining means (84, 85) permitting the seasonings container (82) to be removed for cleaning and/or replacement.

11. An arrangement according to claim 7, wherein said internal wall (81) of the receptacle is formed with retaining means permitting the said foraminate wall (83) of the seasonings container to be removed for cleaning and/or replacement.

12. An arrangement according to claim 7, further comprising a range of interchangeable seasoning containers (e.g. 82), respectively having foraminate walls (e.g. 83) formed with differently dimensioned apertures for liquid ingress and egress and for use with differing kinds of seasoning materials.

13. An arrangement according to claim 7, further comprising a range of interchangeable foraminate walls for said seasoning container (82), said walls being respectively formed with differently dimensioned apertures for liquid ingress and egress and for use with differing kinds of seasoning materials.
